(19) United States
(12) Patent Application Publication
(10) Pub. No.: US 2002/0137489 A1
(43) Pub. Date: Sep. 26, 2002

(54) Method and apparatus for emergency notification

(75) Inventors: Rabindranath Dutta, Austin, TX (US); Janani Janakiraman, Austin, TX (US)

Correspondence Address: Leslie Van Leeuwen, International Business Machines Corporation, Intellectual Property Law Dept. Internal Zip 4054, 11400 Burnet Road,, Austin, TX, 78758, US

(73) Assignee: International Business Machines Corporation

(21) Appl. No.: 09/817,099

(22) Filed: Mar. 26, 2001

(51) Int. Cl. H04M 11/00

(52) U.S. Cl. 455/404; 455/41; 455/66; 455/567

(57) ABSTRACT

A portable apparatus includes telecommunications circuitry operable to communicate on a wireless carrier system, and a slave device coupled to the telecommunications circuitry. The slave device is operable to i) receive a close-range, standard-protocol radio signal notification from a master device affixed to a vehicle, and ii) trigger the telecommunications circuitry to transmit a wireless carrier system notification of the event. The emergency event includes a change above a certain threshold magnitude of speed of the vehicle, a change above a certain threshold magnitude of acceleration of the vehicle, a change above a certain threshold magnitude of rate of acceleration of the vehicle, or deployment of an air bag.

### BACKGROUND OF THE INVENTION

1. Field of the Invention

The present invention relates to emergency notification systems, and more particularly relates to a wireless phone equipped to cooperate with an emergency notification system installed in a vehicle.

2. Related Art

Automotive manufacturers are adding more and more communications features to modem vehicles. For example, General Motors “OnStar” subsidiary reportedly sells wireless computing services for cars, including navigation systems and voice-activated Internet systems that allow drivers to check e-mail and receive news stories, stock quotes, weather and sports scores while in the car. CNET News.com Oct. 16, 2000. It's also reported that a number of car makers offer location based and emergency services over networks using a “global system for mobile communication,” i.e., “GSM,” network. Communications Week International, Feb. 7, 2000. For example, one car maker reportedly has a system which enables drivers to inform emergency services of an accident by pressing a button on the car's dashboard. Id. It is also reported that some wireless carriers are themselves developing applications for the automotive industry which permit communication over a GSM network with a car. Id. Furthermore, software developers are reportedly working on software designed to operate navigation systems, communications and entertainment services in vehicles. Id. Unfortunately, it is an expensive and time-consuming process to develop elaborate systems such as these incorporated directly into automobiles. Also, emergency notification systems which are tied to an automobile may be well-suited for notifying about the status of the automobile, but not for notifying about personal information relating to passengers. Therefore a need exists to improve emergency notification systems for automobiles and similar passenger vehicles.

### SUMMARY

The foregoing need is addressed in one form, in a wireless phone or similar portable device, such as a personal digital assistant, having telecommunications circuitry operable to communicate on a wireless carrier system, and a slave device coupled to the telecommunications circuitry. The slave device is operable to i) receive a close-range, standard-protocol radio signal notification from a master device affixed to a vehicle, and ii) trigger the telecommunications circuitry to transmit a wireless carrier system notification of the event.

As the term “close-range, standard-protocol radio signal” is used herein it shall mean a radio signal of limited power, i.e., for communication reliably no further than 100 feet, according to a protocol for which there is a publicly available, published specification. One such type of close-range, standard-protocol radio signal is a signal which conforms to one of the “Bluetooth” specifications promulgated by the Bluetooth Special Interest Group, available at www.bluetooth.com. (Bluetooth is a trademark of Telefonaktibolaget.)

In related terminology, the term “close-range, standard-protocol network” is used herein to refer to a network formed by devices communicating at close-range, i.e., no more than 100 feet distant, using such a close-range, standard-protocol radio signal.

The term “wireless carrier system” refers to a cellular phone system, such as a system according to the GSM standard in the 900 MHz band, which is now pervasive in developed countries, and permits calling among both wired and cellular phones. It also includes a phone system of similar functionality, but of the satellite type, such as Globalstar. (Globalstar is a trademark of Loral QUALCOMM Satellite Services.)

The emergency event includes a change above a certain threshold magnitude of speed of the vehicle, a change above a certain threshold magnitude of acceleration of the vehicle, a change above a certain threshold magnitude of rate of acceleration of the vehicle, or deployment of an air bag.

This system is advantageous because it is more modular and cheaper than tightly integrating an entire emergency notification system into an automobile. According to an embodiment of the invention, the bulk of the emergency notification application is embedded in the cell phone or similar device, rather than in the automobile. Elements included in the automobile are accordingly reduced. The invented system reuses cell phone wireless communication which is already established between a passenger and cellular carrier.

It is also advantageous that, since a cell phone is personal equipment, a passenger can have already programmed the cell phone with personal information for sending in the event of an emergency. This avoids the necessity for each passenger to communicate personal information to an emergency notification system that is integrated into an automobile.

In another aspect, the slave device includes a slave radio receiver and slave control circuitry. The slave control circuitry is coupled to the telecommunications circuitry and the slave radio receiver and is operable to initiate the wireless carrier system notification of the event by the telecommunications circuitry responsive to the radio signal notification from the master device.

In another form, a notification system is combined with a special wireless device, such as a phone or personal digital assistant. The notification system has a deceleration sensor 312 affixed to a vehicle for detecting and indicating an “emergency event” and a master device affixed to the vehicle and coupled to the sensor. The master device is operable to transmit a close-range, standard-protocol radio signal notification of the event responsive to the sensor indication, which may be received by the wireless phone. The master device has a master radio transmitter, and master control circuitry coupled to the sensor and the master radio transmitter.

In a particular embodiment, the master control circuitry includes a storage device, i.e., memory, and a processor. The processor is coupled to the sensor, the radio transmitter, and the memory. The memory stores software, including an emergency notification program and a close-range, standard-protocol radio signal device driver, for controlling the processor. The processor is operative with the software to initiate the radio signal notification by the radio transmitter responsive to the sensor indication.

In one aspect, the notification system communicates with an ignition interlock which signals when the vehicle is started.

The wireless device has a slave device, including a slave radio receiver operable to receive the radio signal notification from the master device, and slave control circuitry. The phone also has telecommunications circuitry operable to communicate on a wireless carrier system. The slave device is coupled to the telecommunications circuitry and is operable to trigger the telecommunications circuitry to transmit a wireless carrier system notification of the event.

In one embodiment, the slave control circuitry includes a processor and a memory, operable for storing software for controlling the processor. The software includes software for a personal digital assistant (“PDA”), including an operating system, an emergency notification application and other applications. The software also includes a browser, a radio signal device driver and telecommunications circuitry driver. The processor is coupled to the telecommunications circuitry, the radio receiver and the memory, and is operative with the software to initiate the wireless carrier system notification of the event by the telecommunications circuitry responsive to the radio signal notification from the master device.

In another form, a method for generating an emergency notification, includes searching, by a master device affixed to a vehicle, for an apparatus within the vehicle having a slave device operable to communicate via a close-range, standard-protocol radio signal. The apparatus also has telecommunication circuitry operable to communicate via a wireless carrier system. A local network is formed for the master device and the apparatus within the vehicle, responsive to the master device finding the apparatus. The master device is signaled about an emergency event by a sensor affixed to the vehicle. The slave device is signaled about the emergency event by the master device via the close-range, standard-protocol radio signal.

The slave device, responsive to the notification from the master device, triggers the telecommunications circuitry to transmit a wireless carrier system notification of the event.

In one aspect, the method includes looking up emergency notification information by the slave device responsive to the notification by the master device. The emergency notification information includes a message for a particular receiving device, and the step of transmitting the notification to the wireless carrier system by the apparatus comprises transmitting the message.

In a further aspect, the message includes a voice recording or text, and contact information, including a telephone number or electronic mail address for routing the message to the particular receiving device.

Other advantages of the invention will become apparent upon reading the following detailed description and upon reference to the accompanying drawings.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a car with an air bag system and a number of passenger's phones.

FIG. 2 illustrates a notification system communicating with specially equipped phones, and the phones communicating with a wireless carrier system, according to an embodiment of the invention.

FIG. 3A illustrates a prior art air bag system.

FIG. 3B illustrates a prior art wireless phone.

FIG. 4 illustrates a notification system and wireless phone, according to an embodiment of the invention.

FIG. 5 illustrates the notification system of FIG. 4 communicating with a number of wireless phones.

FIG. 6 illustrates a point-to-point network.

FIG. 7 illustrates a point-to-multipoint network.

FIG. 8 illustrates some additional aspects of the emergency notification application of FIG. 4.

FIG. 9 illustrates method steps, according to an embodiment.

FIG. 10 illustrates method steps for certain aspects of communication between the notification system and a wireless phone.

### DETAILED DESCRIPTION OF THE PREFERRED EMBODIMENT

In the following detailed description of the preferred embodiments, reference is made to the accompanying drawings illustrating embodiments in which the invention may be practiced. It should be understood, however, that the drawings and detailed description are not intended to limit the invention to the particular form disclosed, but on the contrary, the intention is to cover all modifications, equivalents and alternatives falling within the spirit and scope of the present invention as defined by the appended claims.

FIG. 1 illustrates an automobile 110 equipped with an air bag system 115 according to an embodiment of the invention. Four wireless phones 120 are illustrated according to an embodiment of the invention, each phone 120 being carried by a passenger in the automobile 110.

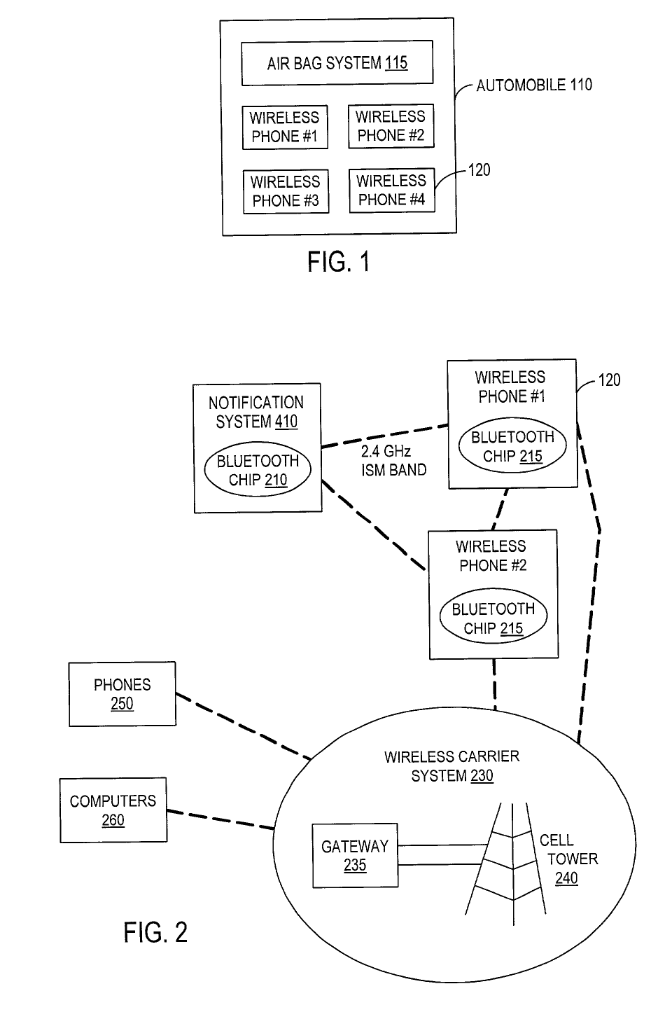

FIG. 2 shows more details of FIG. 1, and additional aspects of an embodiment of the invention. FIG. 2 particularly illustrates the embodiment's application of a Bluetooth wireless communication protocol, for close-range radio communication in the 2.4 gigahertz industrial, scientific, and medical band (“ISM band”) between devices. According to the embodiment, Bluetooth communication is coupled with an existing wireless carrier infrastructure through the use of wireless phones equipped with Bluetooth chips, so that a Bluetooth chip in an air bag system can automatically communicate an air bag event to a device connected to the wireless carrier infrastructure. Specifically, the air bag system 115 in FIG. 2 includes a Bluetooth chip 210. Each wireless phone 120 also includes a Bluetooth chip 215. The Bluetooth chips 215 in the wireless phones 120 communicate with one another, with the Bluetooth chip 210 in the air bag system 115. The phones 120 communicate with the wireless carrier infrastructure 230. The infrastructure 230 includes a gateway 235 and cell tower 240, which also communicates with other phones 250 and other devices, such as computers 260.

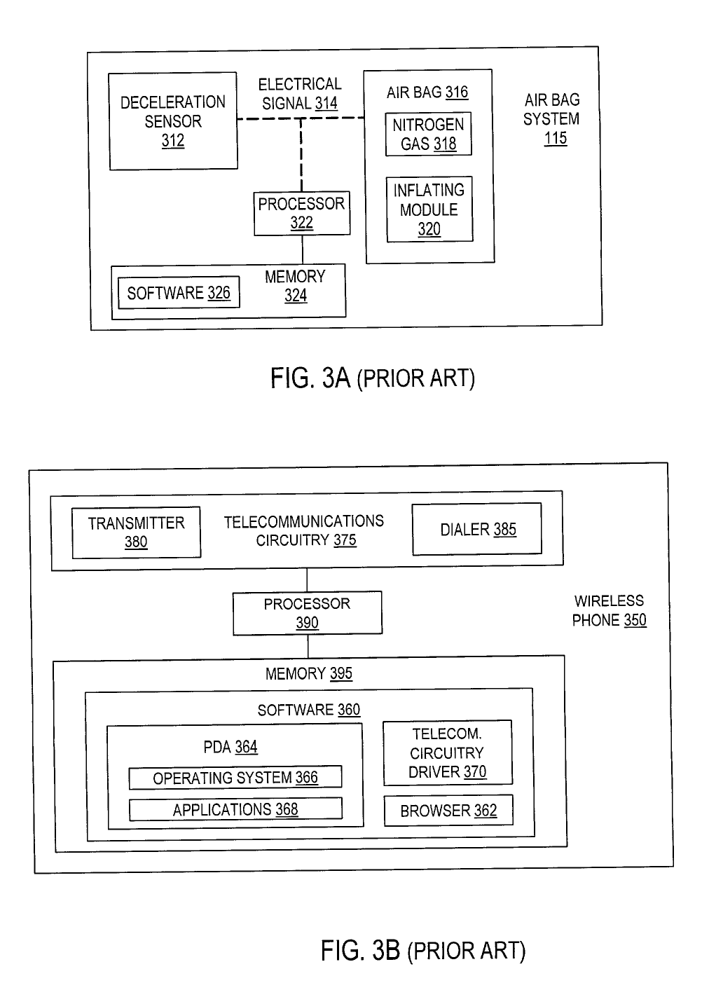

FIG. 3A illustrates a prior art air bag system 115. The system 115 has a deceleration sensor 312 for detecting rapid deceleration of the automobile 110 (FIG. 1), and signaling, via electrical signals 314, to a processor 322 to an air bag assembly 316. The air bag 316 has nitrogen gas 318 and an inflating module 320. The processor 322, in combination with software 360 stored in associated memory 395, operates to process the electrical signal 314 from the deceleration sensor 312 and determine whether the deceleration indication should trigger air bag 316 deployment. If it does, then the inflating module 320 causes the nitrogen gas 318 to be released, which deploys the air bag 316.

FIG. 3A illustrates a prior art wireless phone 350. The phone includes telecommunications circuitry 375 having a dialer 385, i.e., a multi-frequency tone generator, for dialing phone numbers. The circuitry 375 also has a transmitter 380 for sending voice and data. The circuitry also has a receiver, not shown, for receiving messages. The circuitry 375 is coupled to a processor 390, and the processor 390 is coupled to a memory 395 in which software 360 is stored, including personal digital assistant (“PDA”) software 364, which has an operating system 366 and various applications 368. The software 360 also includes a telecommunication circuitry driver 370 and a browser 362.

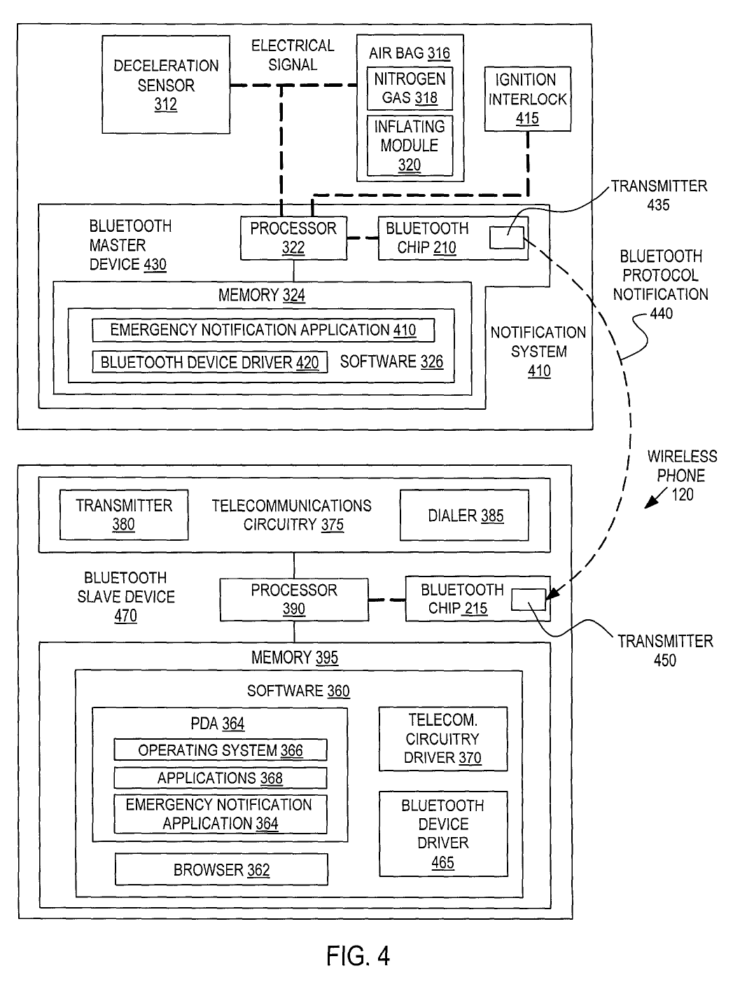

FIG. 4 illustrates a combination of a notification system 410 and a wireless phone 120, according to an embodiment of the invention. The system 410 has a deceleration sensor 312 affixed to the automobile 110 (FIG. 1) for detecting and indicating an “emergency event.” According to various embodiments, the emergency event may be a change above a certain threshold magnitude of speed of the vehicle, a change above a certain threshold magnitude of acceleration of the vehicle, or a change above a certain threshold magnitude of rate of acceleration of the vehicle, for example. Or a different sensor may be used to detect actual deployment of the air bag 316. This may be done by pressure detection, sound, physical contact, or some other way. Some other emergency event, not necessarily even related to the air bag may alternatively be sensed.

The system 410 also has an ignition interlock 415 for signaling when the car 110 (FIG. 1) is started, and a master device 430 affixed to the car 110 and coupled to the sensor 312. The master device 430 is operable to transmit a Bluetooth-protocol radio signal notification 440 of the event responsive to the sensor indication, which may be received by the wireless phone 120. More specifically, the master device has a master radio transmitter 435, which is part of a Bluetooth chip 210, and master control circuitry coupled to the sensor 312 and the master radio transmitter 435 (via the chip 210). In the particular embodiment, the master control circuitry shown includes a storage device, i.e., memory 324, and a processor 322. The processor 322 is coupled to the sensor 312, the radio transmitter 435, via the chip 210, and the memory 324. The memory stores software 326, including an emergency notification program 410 and a Bluetooth device driver 420, for controlling the processor 322. The processor 322 is operative with the software 326 to initiate the Bluetooth-protocol radio signal notification 440 by the radio transmitter 435 responsive to the sensor 312 indication.

The wireless phone 120, which is a portable device of a sufficiently small size for carrying by a person in a coat or trousers pocket, has a slave device 470 operable to receive the Bluetooth-protocol radio signal notification 440 from the master device 430. The phone 120 also has telecommunications circuitry 375 operable to communicate on a wireless carrier system 230 (FIG. 2). The slave device 470 is coupled to the telecommunications circuitry 375 and is operable to trigger the telecommunications circuitry 375 to transmit a wireless carrier system 230 notification of the event.

The slave device 470 includes a slave radio receiver 450 on a Bluetooth chip 215, and slave control circuitry, which in the illustrated embodiment includes a processor 390 and a storage device, i.e., memory 395, operable for storing software 360 for controlling the processor 390. The software 360 in the embodiment includes software for a personal digital assistant (“PDA”) 364, including an operating system 366, an emergency notification application 460 and other applications 368. The software 360 also includes a browser 362, a Bluetooth device driver 465 and telecommunications circuitry driver 370. The processor 390 is coupled to the telecommunications circuitry 375, the radio receiver 450 (via the chip 215), and the memory 395, and is operative with the software 360 to initiate the wireless carrier system notification of the event by the telecommunications circuitry 375 responsive to the Bluetooth-protocol radio signal notification 440 from the master device 430.

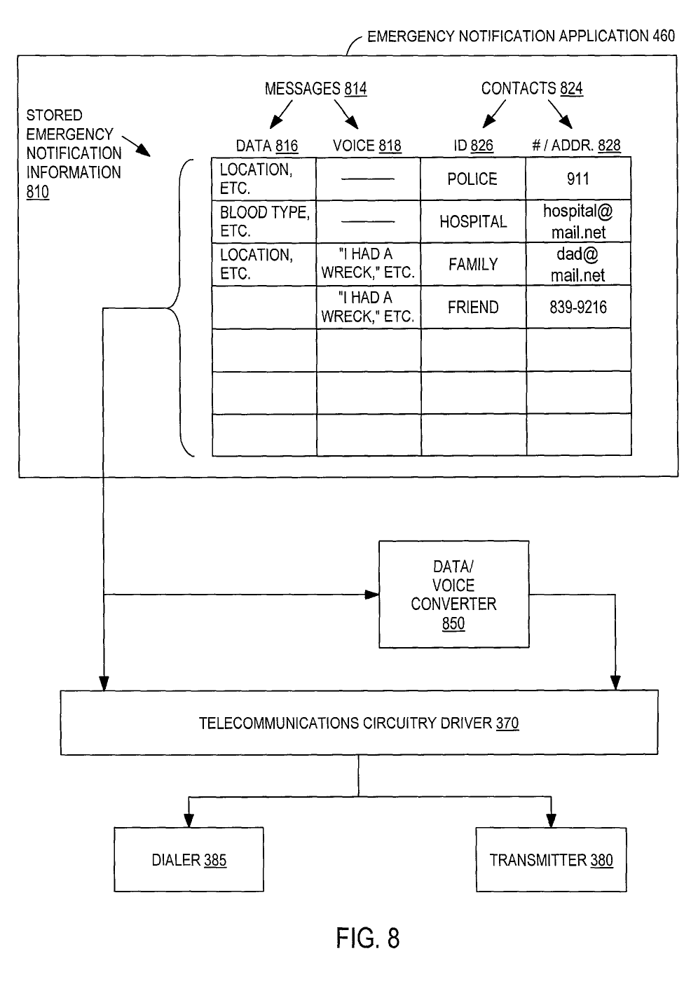

Referring now to FIG. 8, some additional aspects of the emergency application 460 are illustrated, according to an embodiment. As shown, the memory 395 (FIG. 4) is operable for storing emergency notification information 810, including a number of messages 814 for receiving devices, such as phones 250 and/or computers 260 connected to the wireless carrier system 230 (FIG. 2). As shown, the messages includes some which are voice recordings 818, some which are data 816, i.e., text-based, and some which are both. The memory 395 is also operable for storing contact information 824, which in the illustrated embodiment includes identifiers 826, and telephone numbers or electronic mail addresses 828 for routing the message 814 to the receiving device 250 or 260.

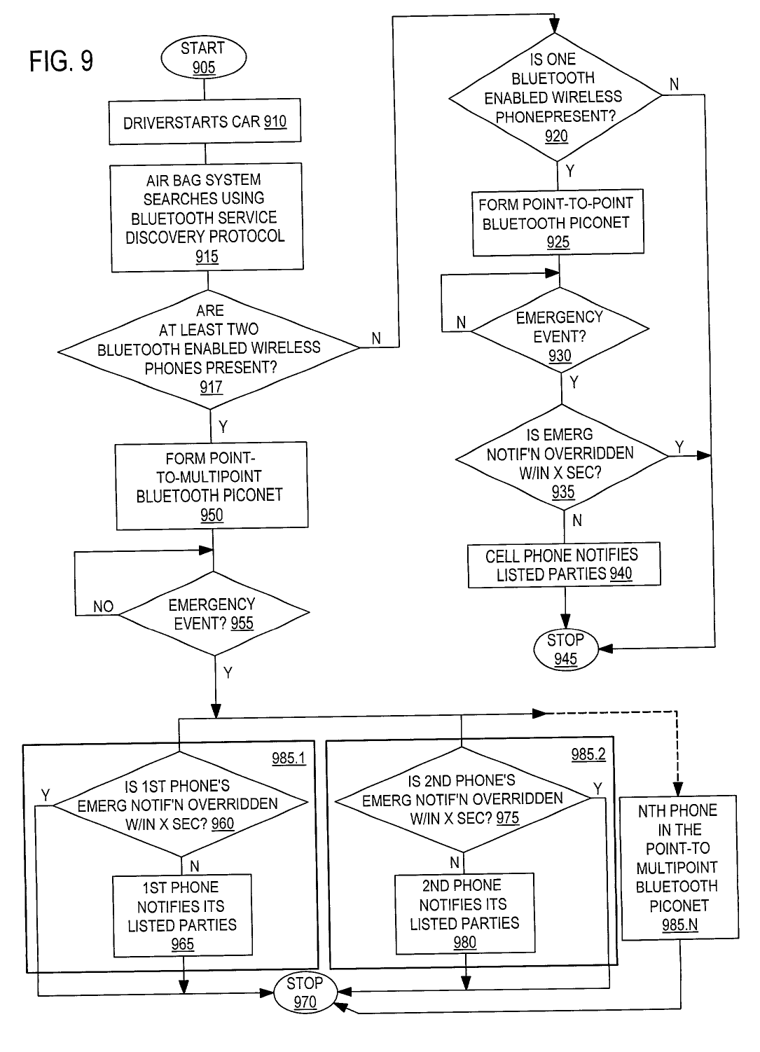

Referring now to FIG. 9, a method for generating emergency notification is illustrated, according to an embodiment of the invention, beginning at 905. The interlock 415 (FIG. 4) signals the processor 322 (FIG. 4) that a driver has started the car 110 (FIG. 1), at 910. This initiates searching by the master device 430 (which is affixed to the vehicle 110) for wireless phones 120 or similar apparatus within the vehicle 110 having respective slave devices 470 operable to communicate via a Bluetooth-protocol radio signal.

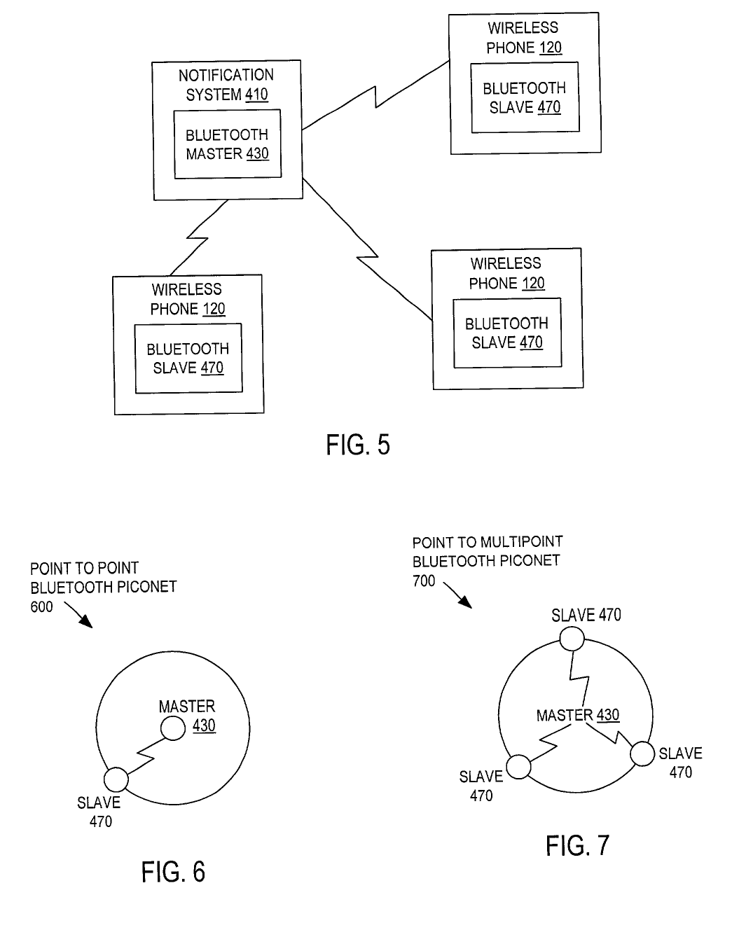

Referring to FIG. 5, a situation is illustrated where there are three wireless phones 120 equipped with slave devices 470 and within range of the master device 430 of the notification system 410, e.g., inside the car 110 (FIG. 1).

FIG. 6 illustrates the case where one slave 470 is located by the master 430 and a point-to-point Bluetooth piconet 600 is formed between the master 430 and the slave 470.

FIG. 7 illustrates the case where three slaves 470 are located by the master 430 and a point-to-multipoint Bluetooth piconet 700 is formed among the master 430 and the multiple slaves 470.

Referring once again to FIG. 9, and also with reference to FIG. 4, a determination is made by the master 430, whether there are at least two Bluetooth-protocol enabled wireless phones present, at 917. If yes, then at 950 a point-to-multipoint Bluetooth piconet 700 (FIG. 7) is formed for the master device 430 and the multiple slaves 470 within the vehicle 110, responsive to the master device 430 finding the Bluetooth-protocol-enabled apparatus 120. If no, then at 920 a determination is made by the master 430, whether there is one Bluetooth-enabled slave 470 within range. If no, the algorithm stops at 945. If yes, then at 925 a point-to-point Bluetooth piconet 600 (FIG. 6) is formed.

For the point-to-point situation, i.e., single slave device 470, the slave 470 monitors the master 430 for an emergency event notification 440 at 930. If an event is indicated, i.e., if the sensor 312 detects an emergency event and signals this to the master device 430, and the master device 430 notifies the slave device 470 of the emergency event by via the Bluetooth-protocol radio signal, then at 935 the slave 470 waits for a certain time interval to see whether the user overrides further notification. This may be done by the slave 470 counting toward a certain time-out value responsive to the notification 440 by the master device 430. The counting is canceled at 935, if an override signal is received from the user, such as by pressing a key or key sequence on the phone 120, before the counting reaches the time-out value. If, on the other hand, the slave device reaches the time-out value then at 940 the slave device 470 triggers the telecommunications circuitry 375 to transmit a wireless carrier system notification of the event. This includes the slave 430 looking up emergency notification information 810 (FIG. 8), sending phone numbers 828 to dialer 385 via the driver 370, for the dialer 370 to dial on the wireless system 230 (FIG. 2). The slave 430 also sends the transmitter 380 voice messages 818, e-mail addresses 828 for routing the messages to a particular receiving device, and text-based data 816 (FIG. 8) for the transmitter 380 to send on the system 230.

For the point-to-multipoint situation, i.e., multiple slave devices 470, each slave 470 monitors the master 430 for an emergency event notification 440 at 950. If an event is indicated, i.e., if the sensor 312 detects an emergency event and signals this to the master device 430, and the master device 430 notifies the slave devices 470 of the emergency event by via the Bluetooth-protocol radio signal, then at 985.1, 985.2, etc. through 985.n, each slave 470 waits for a certain time interval to see whether its respective user overrides further notification. This may be done in the same manner as described above, where the slave 470 counts toward a certain time-out value, etc. Each respective slave device 470 notifies its contacts 824 (FIG. 8) of the emergency event or not, depending on whether its user overrides.

From the above description, it should be clear that the software 360 of the phone 120 includes instructions for storing emergency notification information; instructions for receiving an emergency event notification from a Bluetooth-protocol radio signal receiver affixed to the apparatus; instructions for looking up the emergency notification information responsive to the receiving of the event notification, wherein the emergency notification information includes a message for a receiving device; and instructions for driving telecommunications circuitry affixed to the apparatus responsive to finding the message. Also, the instructions for driving the telecommunications circuitry include instructions for driving the telecommunications circuitry to dial the phone number of the receiving device, or transmit the electronic mail address of the receiving device, and to transmit the message.

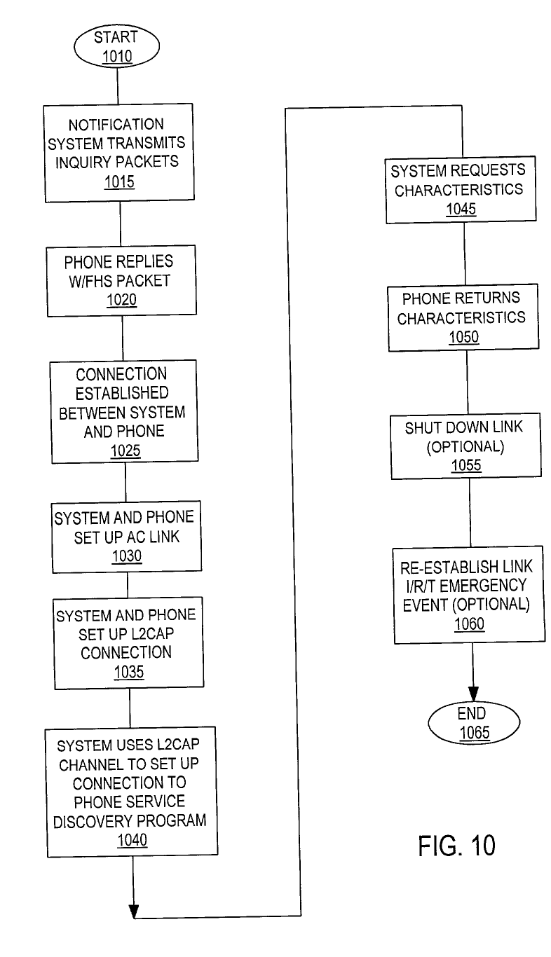

Referring now to FIG. 10, details are shown for some additional aspects of Bluetooth-protocol communication between the master 430 and slave 470 devices, including service discovery aspects, beginning at 1010. At 1015 the notification system 410 master 430 transmits a series of inquiry packets. Then, at 1020 a phone 120 that is within range responds with one or more a frequency hop synchronization packets. At 1025 a connection is established, and at 1030 an asynchronous, connectionless baseband link is established between the phone 120 and the system 410. Then at 1035 a logical link control and adaptation protocol (“L2CAP”) channel is established. Then at 1040 the system 410 uses the channel to set up a wireless phone, i.e., cell phone, service discovery program. Then at 1045 the system 410 requests characteristics from the phone 120 that relate to emergency notification. For example, the phone 120 may support reporting responsive to a degree or type of event, and the phone 120 may therefore report to the system 410 the degree of type event of which the phone 120 should be notified. The system 410 may determine a degree of severity for a crash, based on rate of deceleration, for example.

At 1050 the phone 120 returns the requested characteristics. Optionally at 1055 the link shuts down, and is reestablished at 1060 responsive to indication of an emergency event.

The description of the present embodiment has been presented for purposes of illustration, but is not intended to be exhaustive or to limit the invention to the form disclosed. Many modifications and variations will be apparent to those of ordinary skill in the art. To reiterate, the embodiments were chosen and described in order to best explain the principles of the invention, the practical application, and to enable others of ordinary skill in the art to understand the invention. Various other embodiments having various modifications may be suited to a particular use contemplated, but may be within the scope of the present invention. Those of ordinary skill in the art will appreciate that the hardware and methods illustrated herein may vary depending on the implementation. For example, it should be understood that while the Bluetooth wireless communications protocol is used for the short-range radio communications protocol of the present invention, it would be within the spirit and scope of the invention to encompass an embodiment using another protocol, such as IEEE 802.11. For example, the portable device 120 (FIG. 4) of the described embodiment is a telephone. The device 410 could be a personal digital assistant. Other devices, such multiple processors and memory devices and the like, may be used in addition to or in place of the hardware depicted. The depicted example is not meant to imply architectural limitations with respect to the present invention.

It is important to note that while the present invention has been described in the context of a portable device having a processor and memory, those of ordinary skill in the art will appreciate that the processes of the present invention are capable of being distributed as computer readable medium of instructions in a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

What is claimed is:

1. An apparatus comprising:
a sensor affixed to a vehicle for indicating an emergency event;
a master device affixed to the vehicle and coupled to the sensor, wherein the master device is operable to transmit a close-range, standard-protocol radio signal notification of the event responsive to the sensor indication;
a portable device of a sufficiently small size for carrying by a person, the portable device comprising:
telecommunications circuitry operable to communicate on a wireless carrier system; and
a slave device coupled to the telecommunications circuitry, wherein the slave device is operable to i) receive the close-range, standard-protocol radio signal notification from the master device and ii) trigger the telecommunications circuitry to transmit a wireless carrier system notification of the event.

2. The apparatus of claim 1, wherein the emergency event comprises: a change above a certain threshold magnitude of speed of the vehicle, a change above a certain threshold magnitude of acceleration of the vehicle, a change above a certain threshold magnitude of rate of acceleration of the vehicle or deployment of an air bag.

3. The apparatus of claim 1, comprising an air bag system, wherein the air bag system comprises the sensor.

4. The apparatus of claim 1, wherein the portable device comprises a telephone or a personal digital assistant.

5. The apparatus of claim 1, wherein the master device comprises:
a master radio transmitter; and
master control circuitry, wherein the master control circuitry is coupled to the sensor and the master radio transmitter and is operable to initiate the localized, standard radio signal notification by the master radio transmitter responsive to the sensor indication.

6. The apparatus of claim 1, wherein the slave device comprises:
a slave radio receiver; and
slave control circuitry, wherein the slave control circuitry is coupled to the telecommunications circuitry and the slave radio receiver and is operable to initiate the wireless carrier system notification of the event by the telecommunications circuitry responsive to the close-range, standard-protocol radio signal notification from the master device.

7. The apparatus of claim 5, wherein the master control circuitry comprises a master storage device and a master processor, wherein the master processor is coupled to the sensor, the master radio transmitter and the master storage device, and the master storage device is for storing a master program for controlling the master processor, the master processor being operative with the master program to initiate the close-range, standard-protocol radio signal notification by the master radio transmitter responsive to the sensor indication.

8. The apparatus of claim 6, wherein the slave control circuitry comprises a slave storage device and a slave processor, wherein the slave processor is coupled to the telecommunications circuitry, the slave radio receiver, and the slave storage device, and the slave storage device is operable for storing a slave program for controlling the slave processor, the slave processor being operative with the slave program to initiate the wireless carrier system notification of the event by the telecommunications circuitry responsive to the close-range, standard-protocol radio signal notification from the master device.

9. The apparatus of claim 8, wherein the slave storage device is operable for storing emergency notification information comprising a message for a receiving device connected to the wireless carrier system.

10. The apparatus of claim 9, wherein the message comprises a voice recording or text.

11. The apparatus of claim 9, wherein the slave storage device is operable for storing emergency notification information comprising contact information, wherein the contact information includes a telephone number or electronic mail address for routing the message to the receiving device.

12. The apparatus of claim 1 comprising:
an air bag system, wherein the air bag system comprises the sensor; and
a wireless telephone, wherein the telephone comprises the telecommunications circuitry and the slave device, and wherein the master device comprises:
a master radio transmitter; and
master control circuitry, wherein the master control circuitry is coupled to the sensor and the master radio transmitter and is operable to initiate the close-range, standard-protocol radio signal notification by the master radio transmitter responsive to the sensor indication; and wherein the slave device comprises:
a slave radio receiver; and
slave control circuitry, wherein the slave control circuitry is coupled to the telecommunications circuitry and the slave radio receiver and is operable to initiate the wireless carrier system notification of the event by the telecommunications circuitry responsive to the close-range, standard-protocol radio signal notification from the master radio transmitter.

13. The apparatus of claim 12, wherein the master control circuitry comprises:
a master storage device; and
a master processor, wherein the master processor is coupled to the sensor, the master radio transmitter and the master storage device, and the master storage device is for storing a master program for controlling the master processor, the master processor being operative with the master program to initiate the close-range, standard-protocol radio signal notification by the master radio transmitter responsive to the sensor indication; and wherein the slave control circuitry comprises:
a slave storage device; and
a slave processor, wherein the slave processor is coupled to the telecommunications circuitry, the slave radio receiver, and the slave storage device, and the slave storage device is operable for storing a slave program for controlling the slave processor, the slave processor being operative with the slave program to initiate the wireless carrier system notification of the event by the telecommunications circuitry responsive to the close-range, standard-protocol radio signal notification from the master radio transmitter.

14. An apparatus comprising:
telecommunications circuitry operable to communicate on a wireless carrier system; and
a slave device coupled to the telecommunications circuitry, wherein the slave device is operable to i) receive a close-range, standard-protocol radio signal notification from a master device affixed to a vehicle, and ii) trigger the telecommunications circuitry to transmit a wireless carrier system notification of the event, wherein the apparatus is of a sufficiently small size for carrying by a person in a coat or trousers pocket, and wherein the emergency event comprises a change above a certain threshold magnitude of speed of the vehicle, a change above a certain threshold magnitude of acceleration of the vehicle, a change above a certain threshold magnitude of rate of acceleration of the vehicle, or deployment of an air bag.

15. The apparatus of claim 14, wherein the slave device comprises:
a slave radio receiver; and
slave control circuitry, wherein the slave control circuitry is coupled to the telecommunications circuitry and the slave radio receiver and is operable to initiate the wireless carrier system notification of the event by the telecommunications circuitry responsive to the close-range, standard-protocol radio signal notification from the master device.

16. The apparatus of claim 15, wherein the slave control circuitry comprises:
a slave storage device; and
a slave processor, wherein the slave processor is coupled to the telecommunications circuitry, the slave radio receiver, and the slave storage device, and the slave storage device is operable for storing a slave program for controlling the slave processor, the slave processor being operative with the slave program to initiate the wireless carrier system notification of the event by the telecommunications circuitry responsive to the close-range, standard-protocol radio signal notification from the master device.

17. The apparatus of claim 16, wherein the slave storage device is operable for storing emergency notification information comprising a message for a receiving device connected to the wireless carrier system.

18. The apparatus of claim 17, wherein the message comprises a voice recording or text.

19. The apparatus of claim 17, wherein the slave storage device is operable for storing emergency notification information comprising contact information, wherein the contact information includes a telephone number or electronic mail address for routing the message to the receiving device.

20. The apparatus of claim 14, wherein the emergency event comprises at least one of the following: a change above a certain threshold magnitude of speed of the vehicle, a change above a certain threshold magnitude of acceleration of the vehicle, a change above a certain threshold magnitude of rate of acceleration of the vehicle, deployment of an air bag.

21. The apparatus of claim 14, comprising a telephone, wherein the telephone comprises the telecommunications circuitry and the slave device.

22. The apparatus of claim 14, comprising a personal digital assistant, wherein the personal digital assistant comprises the telecommunications circuitry and the slave device.

23. A method for generating an emergency notification, the method comprising the steps of:
searching, by a master device affixed to a vehicle, for an apparatus within the vehicle, wherein the apparatus has a slave device operable to communicate via a close-range, standard-protocol radio signal, and the apparatus has telecommunication circuitry operable to communicate via a wireless carrier system;
forming a close-range, standard-protocol network for the master device and the apparatus within the vehicle, responsive to the master device finding the apparatus;
signaling the master device of an emergency event responsive to a sensor affixed to the vehicle detecting the event;
notifying the slave device of the emergency event by the master device via the close-range, standard-protocol radio signal responsive to the signal from the sensor; and
triggering, by the slave device responsive to the notification from the master device, the telecommunications circuitry to transmit a wireless carrier system notification of the event.

24. The method of claim 23, comprising the step of:
looking up emergency notification information by the slave device responsive to the notification by the master device, wherein the emergency notification information includes a message for a particular receiving device, and the step of transmitting the notification to the wireless carrier system by the apparatus comprises transmitting the message.

25. The method of claim 24, wherein the message comprises a voice recording or text.

26. The method of claim 24, wherein the emergency notification information includes contact information, wherein the contact information includes a telephone number or electronic mail address for routing the message to the particular receiving device.

27. The method of claim 23, comprising the step of:
counting toward a certain time-out value by the slave device responsive to the notification by the master device, wherein the counting is canceled if an override signal is received before the counting reaches the time-out value, and wherein the step of the slave device triggering the telecommunications circuitry to transmit a wireless carrier system notification of the event is responsive to the slave device reaching the time-out value.

28. A computer program product for an apparatus of a sufficiently small size for carrying by a person in a coat or trousers pocket, the computer program product comprising:
instructions for storing emergency notification information;
instructions for receiving an emergency event notification from a Bluetooth-protocol radio signal receiver affixed to the apparatus;
instructions for looking up the emergency notification information responsive to the receiving of the event notification, wherein the emergency notification information includes a message for a receiving device; and
instructions for driving telecommunications circuitry affixed to the apparatus responsive to finding the message.

29. The computer program product of claim 28, wherein the instructions for driving the telecommunications circuitry comprise instructions for driving the telecommunications circuitry to transmit the message.

30. The computer program product of claim 28, wherein the emergency notification information comprises a phone number for the receiving device, and the instructions for driving the telecommunications circuitry comprise instructions for driving the telecommunications circuitry to dial the phone number of the receiving device.

31. The computer program product of claim 28, wherein the emergency notification information comprises an electronic mail address for the receiving device, and the instructions for driving the telecommunications circuitry comprise instructions for driving the telecommunications circuitry to transmit the electronic mail address of the receiving device.
